(19) United States
(12) Patent Application Publication
(10) Pub. No.: US 2019/0271363 A1
(43) Pub. Date: Sep. 5, 2019

(54) CLUTCH DEVICE

(71) Applicant: SCHAEFFLER TECHNOLOGIES AG & CO. KG, HERZOGENAURACH (DE)

(72) Inventor: Alexander WENISCH, Erlangen (DE)

(73) Assignee: SCHAEFFLER TECHNOLOGIES AG & CO. KG, HERZOGENAURACH (DE)

(21) Appl. No.: 16/319,968

(22) PCT Filed: Oct. 18, 2017
(86) PCT No.: PCT/DE2017/100893

§ 371 Date: Jan. 23, 2019

(30) Foreign Application Priority Data
Nov. 16, 2016 (DE) 10 2016 222 450.6

(51) Int. Cl. F16D 23/14; F16D 15/00; F16D 11/16; F16D 41/069

(52) U.S. Cl. CPC F16D 23/14; F16D 15/00; F16D 2023/123; F16D 41/069; F16D 11/16

(57) ABSTRACT

A clutch device, comprising an inner ring, an outer ring, one or more clutch discs arranged radially between the inner ring and the outer ring, wherein the one or more clutch discs are formed by the plurality of segments arranged next to one another in the peripheral direction and connected to one another via a cage, wherein the segments are configured to contact the outer ring in an unactuated state of the clutch device and configured to come into contact with the inner ring in an actuated state of the clutch device, and a first and second piston, wherein the first and second piston are configured to radially move the segments, wherein the first piston is configured to move at least one portion of the segments in a first peripheral direction in order to actuate the clutch device.

### CROSS-REFERENCE TO RELATED APPLICATIONS

This application is the U.S. National Phase of PCT/DE2017/100893 filed Oct. 18, 2017, which claims priority to DE 102016222450.6 filed Nov. 16, 2016, the entire disclosures of which are incorporated by reference herein.

### TECHNICAL FIELD

The disclosure relates to a clutch device, in particular for a motor vehicle. Clutch devices in motor vehicles, in particular in transmissions of motor vehicles are usually designed as a multiple disk clutch or as a claw clutch. Multiple disk clutches are frictionally engaged clutch devices which can basically be actuated by means of an axial force. Claw clutches are frictionally engaged clutch devices, that provide lesser shifting comfort than multiple disk clutches, but which require a lower actuating force.

### BACKGROUND

A shiftable clutch can be derived from e.g. the DE 10 2013 220 224 A1. The clutch comprises a first outer ring, a second outer ring, an inner ring, at least one wedge block that is arranged at least partially radially between the inner ring and the first and second outer rings, and one single actuator rod, which can be moved in order to position the at least one wedge block. The first outer ring and the inner ring are rotatably connected to each other in a first position for the actuator rod and for the at least one wedge block. The second outer ring and the inner ring are rotatably connected to each other in a second position for the actuator rod and for the at least one wedge block. In a third position for the actuator rod and for the at least one wedge block, the inner ring can be rotated in relation to the first and second outer ring.

### SUMMARY

One of the objectives of the present disclosure to further develop a clutch device in such a way that in particular a shifting comfort of the clutch device is increased and an actuating force for the actuating of the clutch device is reduced.

The clutch device according to the disclosure comprises an inner ring and an outer ring as well as at least one clutch disc that is arranged radially between the inner ring and the outer ring, which is formed by a plurality of segments that are arranged adjacent to each other in circumferential direction as well as that are elastically connected to each other via a cage, wherein the segments only come into contact with the outer ring in an unactuated state of the clutch device, and wherein the segments also come into contact with the inner ring in an actuated state of the clutch device, in order to generate a frictional torque for the transmitting of torque between the inner ring and the outer ring, wherein the outer ring features a plurality of ramps on an inner circumferential surface, which interact with correspondingly designed ramps on a respective outer circumferential surface of the respective segment, and wherein the segments can be radially displaced via a first and a second piston that can be operated in axial direction, wherein the first piston is provided to displace at least one portion of the segments in a first circumferential direction in order to actuate the clutch device, and wherein the second piston is provided to displace at least another portion of the segments in a second circumferential direction, in the opposite direction to the first circumferential direction, in order to actuate the clutch device.

In other words, a gap between the at least one clutch disc and the inner ring is formed in the unactuated state of the clutch device, so that the inner ring and the at least one clutch disc do not come into contact with each other, wherein no torque is transmitted between the inner ring and the outer ring. In contrast, the least one clutch disc comes to rest radially on the inner ring and on the outer ring in an actuated state of clutch device. A radial displacement of at least a portion of the segments is initiated by means of an axial operating of at least one of the two pistons. It is particularly possible that either the first piston or the second piston is operated. The operating of the first and second piston separately from each other allows for a performance-optimized actuating of the clutch device during a pushing and pulling operation. In other words, one of the two pistons for the actuating of the clutch device is intended for the pushing operation, wherein the other piston for the actuating of the clutch device is intended for the pulling operation. In particular the actuating force and thus also the oil consumption can be reduced in this way. It is furthermore possible that both pistons are actuated at the same time in order to move all the segments simultaneously and thereby to actuate the clutch device. The radial displacement of the segments leads to a wedging of the at least one clutch disc between the outer ring and the inner ring and thus results in a frictionally locked connection. The shifting comfort is hereby particularly increased.

The two pistons may be guided on a ring element in such a way that they can be moved in axial direction. Axial grooves for the guiding on the ring element are formed at the respective piston for this purpose. The respective piston is particularly guided by means of multiple axial grooves that are provided for this purpose on the circumference of the ring element. Consequently, the respective piston is rotationally connected to the ring element. The ring element is arranged in such a manner with regard to the outer ring, that it cannot rotate.

The respective piston may feature multiple wedge elements that are designed in an axial manner, which are tangentially arranged between two respective segments, wherein the respective wedge element is intended to interact with the respective segment in a tangential manner. The respective piston is particularly designed in a ring-shaped manner. The respective wedge element is designed in such a way that one end of each wedge element, which is designed on the respective piston, is wider in tangential direction than an open end of each wedge element. The more the piston is moved axially in the direction of the clutch disc, the further the segments that are provided for it are displaced in tangential direction. The tangential displacement of the segments on the outer ring is connected to a mutual sliding of the ramps on the outer ring and of the ramps at the segments, so that a radial displacement of the respective segments is realized in this way.

Two respective wedge elements may be arranged in circumferential direction after two successive segments in a tangential manner between two segments. In other words, two wedge elements and then no wedge element are alternately arranged between two segments. Thus, the piston comprises as many wedge elements as the clutch disc comprises segments. One wedge element is provided to operate one individual segment.

According to one embodiment, two respective ramps may form a partial circle contour on the outer ring together. As a result, a wedging of the clutch disc is implemented, which is not dependent on the rotation direction. The ramps thus function in a bidirectional manner. Furthermore, other ramp contours are also possible that implement a wedging of the clutch disc that is not dependent on the rotation direction. The ramps are particularly formed on the outer ring in circumferential direction alternatingly in a radially increasing and in a radially decreasing manner. An outer circumferential surface of the inner ring is formed in a cylindrical manner.

The disclosure includes the technical teaching that the segments are arranged in a circumferential groove on the inner ring, wherein the segments come into frictional engagement in the circumferential groove in the actuated state of the clutch device. The circumferential groove is particularly intended to fasten the segments in axial direction and to reduce the actuating force for the clutch device.

The segments may be designed in an essentially wedge-shaped manner towards the radial inside. In other words, the segments at least partially taper towards the radial inside. In particular the circumferential groove on the inner ring is designed in a complementary way with regards to the segments. As a result, the contact surface between the respective segment and the inner ring is increased. Consequently, the normal force and thus also the frictional torque between the respective segment and the inner ring is increased.

The respective segment may be mounted radially via two respective spring elements at the cage, wherein the two respective spring elements press the respective segment in radial direction against the outer ring in the unactuated state of the clutch device. The spring elements may be designed as compression springs and are supported radially between the cage and the respective segment.

The outer ring may be rotatably connected to the housing. The housing may e.g. refer to a gearbox housing or another torque transferring component, such as, for example, a planetary carrier. A form-fitting structure is particularly established between the housing or this component and the outer ring, which prevents a rotating of the outer ring in relation to the fixed component or in relation to the housing.

### BRIEF DESCRIPTION OF THE DRAWINGS

A design example of the disclosure is explained in more detail on the basis of the drawings in the following, in which identical or similar elements are identified with the same reference signs. It is shown

FIG. 1 a schematic sectional depiction to illustrate the structure of a clutch device according to the disclosure,

FIG. 2 an enlarged schematic sectional depiction of the clutch device according to the disclosure in accordance with FIG. 1 in an unactivated state, and

FIG. 3 a further enlarged schematic sectional depiction of the clutch device according to the disclosure in accordance with FIG. 1 in an activated state.

### DETAILED DESCRIPTION

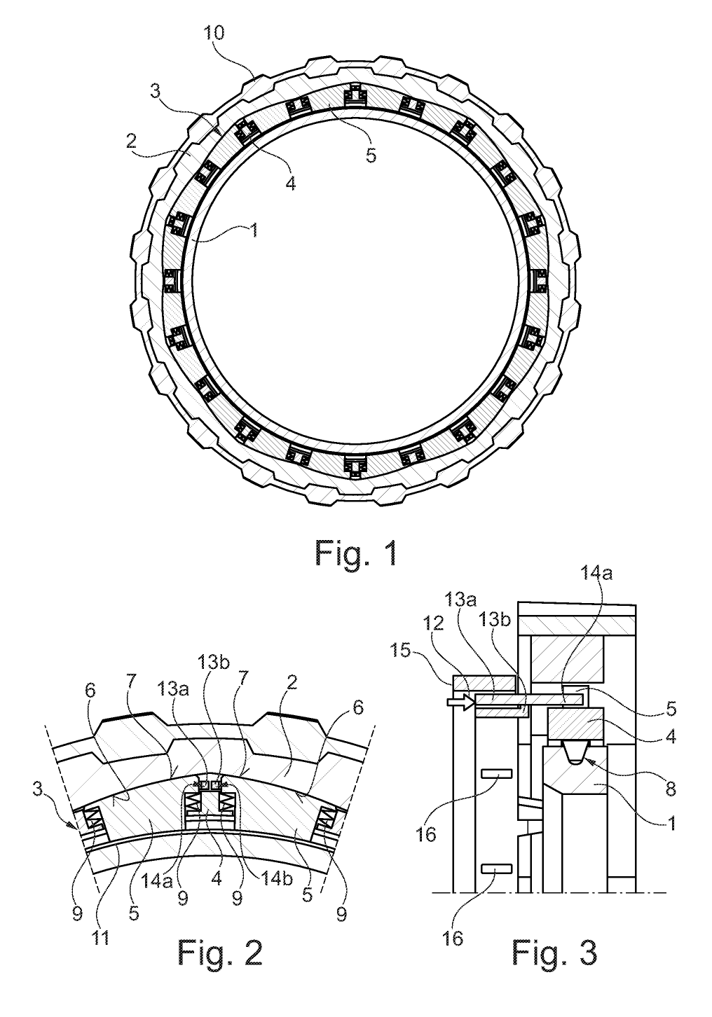

According to FIG. 1, a clutch device according to the disclosure for a—not depicted—motor vehicle comprises an inner ring 1, an outer ring 2 and a clutch disc 3 that is arranged radially between the inner ring 1 and the outer ring 2. The outer ring 2 is rotatably connected to a housing 10. A form-fitting structure is particularly formed between the outer ring 2 and the housing 10, which prevents a relative rotating between the outer ring 2 and the housing 10. The clutch disc 3 is made up of a plurality of segments 5 that are arranged circumferentially adjacent to each other as well as that are interconnected by means of a cage 4.

According to FIG. 2, the respective segment 5 is mounted radially via two respective spring elements 9 at the cage 4. In a—herein depicted—unactuated state of the clutch device, the respective segment 5 is pressed in radial direction against the outer ring 2 by means of the two respective spring elements 9. Therefore, the segments 5 come to rest in radial direction on an inner circumferential surface of the outer ring 2. The outer ring 2 furthermore features a plurality of ramps 6 on an inner peripheral surface, which interact with correspondingly designed ramps 7 on a respective outer peripheral surface of the respective segment 5, in order to cause a radial displacement of the respective segment 5 when a radial rotation occurs between the outer ring 2 and a respective segment 5. In such a case, two respective ramps 6 form a partial circle contour on the outer ring 2 together.

The segments 5 are tangentially displaceable via a first and a second piston 13a, 13b that can be operated in axial direction. The first piston 13a is provided to displace at least a portion of the segments 5 into a first circumferential direction, in the current case in counterclockwise direction, in order to actuate the clutch device. The second piston 13b is provided to displace the remaining portion of the segments 5 into a second circumferential direction, in the current case in clockwise direction, in order to actuate the clutch device. Thus, a distinction is made between an actuation of the clutch device by means of a pushing operation and by means of a pulling operation.

The two pistons 13a, 13b are designed in a ring-shaped manner and feature a respective plurality of axially formed wedge elements 14a, 14b, which are arranged tangentially between two respective segments 5, in order to distance the two respective segments 5 tangentially from each other when the respective piston 13a, 13b is operated and to thereby move at least one segment 5 in tangential direction. The two respective wedge elements 14a, 14b are respectively arranged in circumferential direction after two successive segments 5 in a tangential manner between two segments 5.

In an unactuated state of the clutch device, the segments 5 only come into contact with the outer ring 2, wherein a radial gap 11 is formed between the inner ring 1 and the clutch disc 3, in particular between the inner ring 1 and the segments 5. Thus, no torque is transmitted between the inner ring 1 and the outer ring 2. An axial force can be applied to the two pistons 13a, 13b in order to operate the segments 5 in radial direction.

In an activated state of the clutch device, the segments 5 also come into contact with the inner ring 1, in order to generate a frictional torque for the transmitting of torque between the inner ring 1 and the outer ring 2. The reason for this is the induced tangential displacement of the respective segments 5 due to the axial shifting of the respective piston 13a, 13b. The segments 5 are radially displaced via the interaction of the ramps 6 on the outer ring 2 and of the ramps 7 on the respective segment 5. In other words, the inner ring 1 is coupled and thus rotationally fixed to the outer ring 2 via the clutch disc 3 in the actuated state of the clutch device. Due to the ramps 6 on the outer ring 2 as well as the correspondingly formed ramps 7 on the respective segment 5, a wedging of the clutch disc 3 between the outer ring 2 and the inner ring 1 is carried out after a slight relative rotation between the clutch disc 3 and the outer ring 2. Due to this wedging in the actuated state of the clutch device, the frictional torque is increased for the transmitting of torque between the inner ring 1 and the outer ring 2.

In FIG. 3, the clutch device is shown in the actuated state in accordance with another sectional depiction. It can be particularly derived from FIG. 3 that the segments 5 that are held by cage 4 are arranged within a circumferential groove 8 on the inner ring 1. In the activated state of the clutch device, the segments 5 come to rest within the circumferential groove 8. An arrow 12 illustrates an axial force that is applied onto the first piston 13a, which has shifted the wedge elements 14a in axial direction between two respective segments 5 and thereby has displaced the respective segment 5 in tangential direction, and thus also in radial direction. The second piston 13b has not been operated. The two pistons 13a, 13b are guided on a ring element 15 in such a way that they can be moved in axial direction. Therefore, the two pistons 13a, 13b feature axial grooves 16 for the guiding on the ring element 15, wherein the axial grooves 16 are evenly arranged around the circumference of the respective piston 13a, 13b. Due to the radial displacement of the respective segments 5, the displaced segments 5 come to rest within the radial groove 8 on the inner ring 1. The segments 5 are essentially wedge-shaped towards the radial inside, particularly in a trapezoidal-shape in cross-section. Furthermore, the groove 8 is essentially formed in a complementary manner with regards to the segments 5 in order to prevent a tilting of the respective segment 5.

### LIST OF REFERENCE SIGNS

1 Inner ring

2 Outer ring

3 Clutch disc

4 Cage

5 Segments

6 Ramp

7 Ramp

8 Groove

9 Spring element

10 Housing

11 Gap

12 Arrow

13a, 13b Piston

14a Wedge element

14b Wedge element

15 Ring element

16 Groove

1. A clutch device, comprising:
an inner ring;
an outer ring;
at least one clutch disc that is arranged radially between the inner ring and the outer ring, wherein the at least one clutch disc is formed by a plurality of segments that are arranged adjacent to each other in circumferential direction and elastically connected to each other via a cage, wherein the segments are configured to contact the outer ring in an unactuated state of the clutch device and contact the inner ring in an actuated state of the clutch device to generate a frictional torque for the transmitting of torque between the inner ring and the outer ring, wherein the outer ring features a plurality of ramps on an inner circumferential surface, which interact with correspondingly designed ramps on a respective outer circumferential surface of the respective segment, and wherein the segments can be radially moved via a first and a second piston that can be operated in axial direction, wherein the first piston is provided to displace at least one portion of the segments in a first circumferential direction in order to actuate the clutch device, and wherein the second piston is provided to displace at least another portion of the segments in a second circumferential direction, in the opposite direction to the first circumferential direction, in order to actuate the clutch device.

2. The clutch device of claim 1, wherein the first and second pistons are guided on a ring element in such a way that they can be moved in axial direction.

3. The clutch device of claim 2, wherein the two pistons feature axial grooves for the guiding on the ring element.

4. The clutch device of claim 3, wherein the first and second piston includes a plurality of wedge elements that are designed in an axial manner and are tangentially arranged between two respective segments, wherein one of the wedge elements is intended to interact with the respective segment in a tangential manner.

5. The clutch device of claim 4, wherein two respective wedge elements are arranged in circumferential direction after two successive segments in a tangential manner between two segments.

6. The clutch device of claim 5, wherein two respective ramps form a partial circle contour on the outer ring together.

7. The clutch device of claim 6, wherein the segments are designed in an essentially wedge-shaped manner towards the radial inside.

8. The clutch device of claim 7, wherein the segments are arranged in a circumferential groove on the inner ring and the segments come into frictional engagement in the circumferential groove in the actuated state of the clutch device.

9. The clutch device of claim 8, wherein the respective segment is mounted radially via two respective spring elements at the cage, wherein the two respective spring elements press the respective segment in radial direction against the outer ring in the unactivated state of the clutch device.

10. The clutch device of claim 1, wherein the outer ring is rotatably connected to a housing.

11. A clutch device, comprising:
an inner ring;
an outer ring including a plurality of ramps on an inner peripheral surface, wherein the plurality of ramps are configured to cooperate with correspondingly designed ramps on a respective outer peripheral surface of one of a plurality of segments;
one or more clutch discs arranged radially between the inner ring and the outer ring, wherein the one or more clutch discs are formed by the plurality of segments arranged next to one another in the peripheral direction and connected to one another via a cage, wherein the segments are configured to contact the outer ring in an unactuated state of the clutch device and configured to come into contact with the inner ring in an actuated state of the clutch device; and
a first and second piston, wherein the first and second piston are configured to radially move the segments, wherein the first piston is configured to move at least one portion of the segments in a first peripheral direction in order to actuate the clutch device, and the second piston is configured to move at least another portion of the segments in a second peripheral direction in order to actuate the clutch device.

12. The clutch device of claim 11, wherein the second peripheral direction is opposite the first peripheral direction.

13. The clutch device of claim 11, wherein the outer ring is rotatably connected to a housing.

14. The clutch device of claim 11, wherein the first and second pistons are guided on a ring element in such a way that they can be moved in axial direction.

15. The clutch device of claim 14, wherein the two pistons feature axial grooves for the guiding on the ring element.

16. The clutch device of claim 11, wherein a gap is formed between at least one clutch disc and the inner ring in the unactuated state of the clutch device.

17. The clutch device of claim 11, wherein the segments are arranged in a circumferential groove on the inner ring and the segments come into frictional engagement in the circumferential groove in the actuated state of the clutch device.

18. A clutch device, comprising:
an inner ring;
an outer ring;
one or more clutch discs arranged radially between the inner ring and the outer ring, wherein the one or more clutch discs are formed by a plurality of segments arranged next to one another in a peripheral direction and connected to one another via a cage, wherein the segments are configured to contact the outer ring in an unactuated state of the clutch device and configured to come into contact with the inner ring in an actuated state of the clutch device; and
a first piston configured to move at least one portion of the segments in a first peripheral direction in order to actuate the clutch device.

19. The clutch device of claim 18, wherein the outer ring further includes a plurality of ramps on an inner peripheral surface of one of the plurality of segments, wherein the plurality of ramps are configured to cooperate with correspondingly designed ramps on a respective outer peripheral surface of one of the plurality of segments.

20. The clutch device of claim 18, wherein the clutch device further includes a second piston configured to move at least another portion of one of the plurality of segments in a second peripheral direction in order to actuate the clutch device.
